(19) United States
(12) Patent Application Publication
(10) Pub. No.: US 2015/0120436 A1
(43) Pub. Date: Apr. 30, 2015

(54) SYSTEMS, METHODS, AND COMPUTER-READABLE-MEDIA FOR DETERMINING A MULTILOCATION PREDICTED CLICK-THROUGH RATE FOR ADVERTISEMENTS

(71) Applicant: Google Inc., Mountain View, CA (US)

(72) Inventors: Krzysztof Duleba, Pfaffikon (CH); Ingemar Eriksson, Zurich (CH)

(73) Assignee: Google Inc., Mountain View, CA (US)

(21) Appl. No.: 13/656,387

(22) Filed: Oct. 19, 2012

(51) Int. Cl. G06Q 30/02

(52) U.S. Cl. CPC G06Q 30/0246; G06Q 30/0256
USPC 705/14.45; 705/14.54; 705/14.58

(57) ABSTRACT

Provided are systems and methods for determining a multilocation predicted click-through rate (pCTR) for advertisements. The multilocation pCTR may be used to select and rank advertisements for advertisement auctions presented to potential advertisers. The multilocation pCTR may be based on a set of locations and probabilities for an estimation of a user's location, such by internet protocol (IP) address geolocation. The multilocation pCTR for an advertisement and a location set may then be determined from the single location pCTR for each location of the location set and the probability associated with each location.

### BACKGROUND OF THE INVENTION

1. Field of the Invention

This invention relates generally to advertisements on the Internet and, more particularly, to providing click-through rate information for advertisements.

2. Description of the Related Art

The Internet is useful for a variety of purposes, such as for serving different types of content to users and providing information to users. For example, users may use the Internet to perform searches, such as searches for restaurants, bars, businesses, products, events, etc. These searches may be performed by a search engine that presents search results to a user. A user may also use the Internet to access websites having various types of content, such as news stories, music, film, and game reviews, encyclopedic articles, and so on.

In an attempt to monetize various aspects of the Internet, advertisements are presented when a user retrieves information and views content. Advertisements are targeted to a user based on the information and the content, such as an executed search query, search results, keywords in the viewed content, and the like. The advertisements may be sold through various mechanisms, such as auctions, and advertisers may bid on advertisements. The advertisement provided at auction and selected by advertisers may also be targeted based on the user-specific information, such as the user's location. The user's location may be difficult to determine, however, and the determination may not include an accurate estimation.

### SUMMARY OF THE INVENTION

Various embodiments of methods, systems, and computer-readable media for determining a multilocation predicted click-through rate are provided herein. In some embodiments, a computer-implemented method for determining a multilocation predicted click-through rate for advertisements is provided. The method includes receiving, at one or more processors, a search query from a client computer and receiving, at one or more processors, a location set corresponding to the client computer. The location set has a plurality of locations associated with a respective plurality of probabilities that the client computer is located at a respective location of the plurality of locations. The method also includes receiving, at one or more processors, a plurality of advertisements based on the search query, determining, by one or more processors, a multilocation predicted click-through rate (pCTR) for each of the plurality of advertisements. The multilocation pCTR can be a function of the plurality of locations, a single location pCTR for each location of the location set, and the respective plurality of probabilities, for example. The method further includes providing, by one or more processors, one or more of the plurality of advertisements to an advertisement auction based on the multilocation pCTR, whereby advertisers may bid the one the one or more advertisements in the advertisement auction.

Additionally, in some embodiments, a non-transitory tangible computer-readable storage medium having executable computer code stored thereon for determining a multilocation predicted click-through rate for advertisements is provided. The code includes a set of instructions that causes one or more processors to perform the following: receiving, at one or more processors a search query from a client computer and receiving, at one or more processors, a location set corresponding to the client computer. The location set has a plurality of locations associated with a respective plurality of probabilities that the client computer is located at a respective location of the plurality of locations. The set of instructions also perform the following: receiving, at one or more processors, a plurality of advertisements based on the search query and determining, by one or more processors, a multilocation predicted click-through rate (pCTR) for each of the plurality of advertisements. The multilocation pCTR can be a function of the plurality of locations, a single location pCTR for each location of the location set, and the respective plurality of probabilities, for example. The set of instructions further perform the following: providing, by one or more processors, one or more of the plurality of advertisements to an advertisement auction based on the multilocation pCTR.

Further, in some embodiments, a system for determining a multilocation predicted click-through rate for advertisements is provided. The system includes one or more processors and a memory accessible by the one or more processors. The memory has computer code stored thereon. The code includes a set of instructions that causes one or more processors to perform the following: receiving, at one or more processors a search query from a client computer and receiving, at one or more processors, a location set corresponding to the client computer. The location set has a plurality of locations associated with a respective plurality of probabilities that the client computer is located at a respective location of the plurality of locations. The set of instructions also perform the following: receiving, at one or more processors, a plurality of advertisements based on the search query and determining, by one or more processors, a multilocation predicted click-through rate (pCTR) for each of the plurality of advertisements. The multilocation pCTR can be a function of the plurality of locations, a single location pCTR for each location of the location set, and the respective plurality of probabilities. The set of instructions further perform the following: providing, by one or more processors, one or more of the plurality of advertisements to an advertisement auction based on the multilocation pCTR.

### BRIEF DESCRIPTION OF THE DRAWINGS

FIG. 1 is a schematic diagram that illustrates a system for determining a multilocation predicted click-through rate (pCTR) in accordance with embodiments of the present invention ;

FIG. 2 is a diagram of the determination of a multilocation pCTR for an advertisement in accordance with embodiments of the present invention;

FIG. 3 is a flowchart of a process for estimating a user's location and determining a multilocation pCTR in accordance with embodiments of the present invention;

FIG. 4 is a flowchart of a process for using multilocation pCTR values in advertisement auctions in accordance with embodiments of the present invention; and

FIG. 5 is a diagram of a computer in accordance with embodiments of the present invention.

Although the invention is susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION OF THE PREFERRED EMBODIMENTS

As discussed in more detail below, provided in some embodiments are systems and methods for determining a multilocation predicted click-through rate (pCTR) for advertisements. The multilocation pCTR is used to select and rank advertisements for advertisement auctions presented to potential advertisers. The multilocation pCTR is based on an estimation of a user's location, such as by internet protocol (IP) address geolocation. The location estimation may include a location set having multiple locations, and each location of the location set is associated with a probability that the user is located in the respective location.

The multilocation pCTR for an advertisement and a location set is determined from the single location pCTR for each location of the location set. The single location pCTR for an advertisement is a function of a search query, the advertisement, a context, the location, or a combination thereof. Additionally, the single location pCTR is determined from data obtained from historical click-through rates for similar search queries, advertisements, contexts, and locations. For a location set having locations and probabilities, the multilocation pCTR for a location set and advertisement is determined from a sum of each single location pCTR for each location of the location set multiplied by the associated probability. The multilocation pCTR values for advertisements are then used to select and rank advertisements in an advertisement auction. For example, advertisements having a higher multilocation pCTR may be more desirable to potential advertisers and are therefore subject to higher bids at an advertisement auction.

Additionally, in some embodiments, the multilocation pCTR is combined with advertisement eligibility criteria. The advertisement eligibility criteria may include advertiser restrictions or other criteria. For example, advertisements selected at auction are selected based on a comparison between a location restriction and the highest probable location of the location set. In other embodiments, a location restriction is compared to multiple locations of the location set, such that any location of the location set that meets the location restrictions may result in an eligible advertisement.

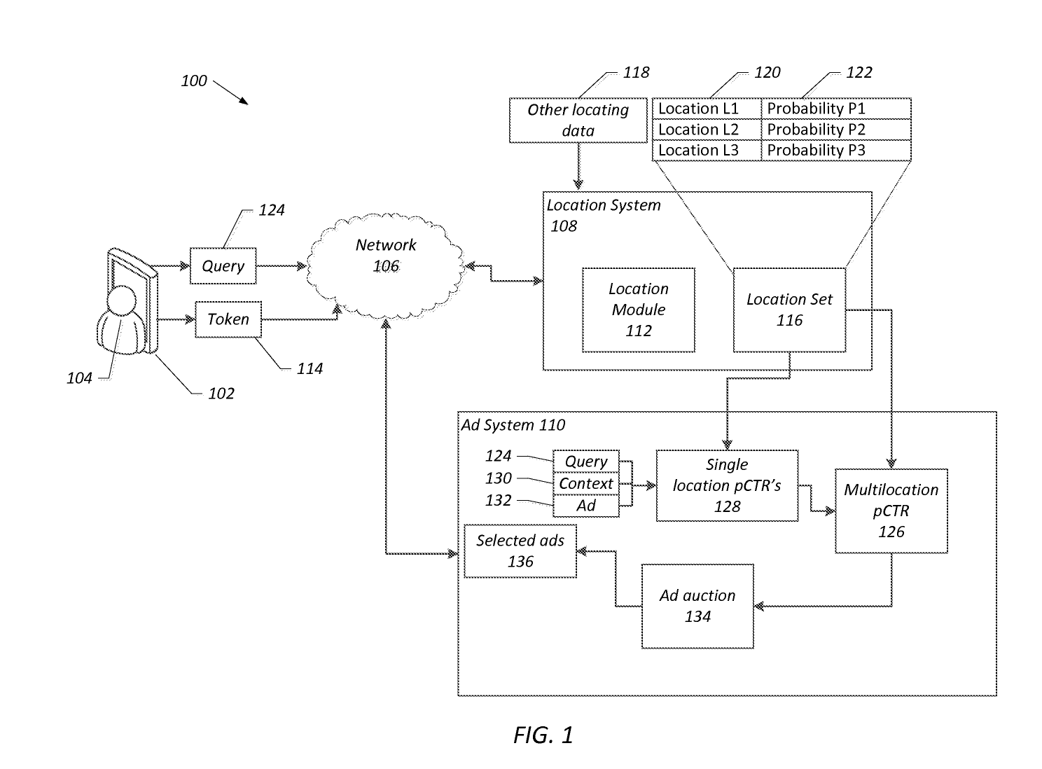

FIG. 1 schematically illustrates a system 100 for determining a multilocation pCTR in accordance with embodiments of the present invention. As shown in FIG. 1, the system 100 includes a client computer 102 and a user 104 of the client computer 102. The system 100 also includes a network 106, a location system 108, and an advertisement system 110. The client computer 102, location system 108, and advertisement system 110 may communicate with each other over the network 106. For example, the client computer 102 may transmit data to and receive data from the location system 108, and the advertisement system 110. In some embodiments, the client computer 102 may include thick-clients, thin-clients, or both. The client computer 102 may include, for example, smartphones, tablet computers, laptop computers, desktop computers, etc. In some embodiments, the system 100 includes multiple client computers 102. Additionally, some embodiments include a proxy, gateway, or other component located between the client computer 102 and other components of the system 100. For example, a router or mobile proxy computer may be located between the client computer 102 and the network 106. In other embodiments, the client computer 102 may access the network 106, the location system 108, or other components of the system 100 via a service provided by another entity.

The network 106 includes any element or system that facilitates communications between the components of system 100. The network 106 may include an electronic communication network and may include any suitable network, such as the Internet, an intranet, a local area network (LAN), a wide area network (WAN), a cellular communications network or any other suitable network, and may be a wireless or wired network. The network 106 may facilitate data exchange by way of packet switching using the Internet Protocol (IP). Network 106 may facilitate wired and/or wireless connectivity and communication. The network 106 may include a single network or combination of networks (e.g., the Internet and a cellular communications network as understood by those skilled in the art) that facilitate communication between the components of system 100. In some embodiments, the components of the system 100 are each associated with a given IP. The IP address may include an IPv4 IP address, an IPv6 IP address or the like.

The location-based system 108 and the advertisement system 110 may each be implemented on a single server (in a discrete hardware component or as a virtual server) or multiple servers. Such servers include web servers, application servers, or other types of servers. The servers include, for example, computers arranged in any physical and virtual configuration, such as computers in one or more data processing centers, a distributed computing environment, or other configuration. Such configurations may use the network 106 for communication or may communicate over other networks

The location system 108 includes a location processing module 112 that determine the geographical location of a component of the system 100, such as by geolocation based on a token 114 (e.g., one or more tokens) received from the client computer 102, information associated with a user of the client computer 102, information associated with the client computer 102, or a combination thereof. In some embodiments, the location system 108 provides geolocation of components based on IP addresses associated with the components (referred to as “IP address geolocation”). For example, the location system 108 obtains, accesses, and processes IP addresses and geolocation data corresponding to the IP addresses to generate a mapping of IP addresses to real-world physical/geolocations (e.g., geographic coordinates, a physical address, zip-code, city, state, country, continent, time zone or the like). Upon receiving request for geolocation data associated with a given IP address, the location system provides a geolocation associated with the IP address based on the mapping. In some embodiments, the location system 108 accesses other systems to determine the location of a component. For example, the location system 108 may access a WHOIS service to determine the registrant of an IP address or a database of mapped IP addresses. In some embodiments, IP addresses and geolocation data are collected from requests received from access devices.

In other embodiments, the location processing module 112 geolocates the client computer based on historical behavior associated with the client computer 102 or the user 104 of the client computer 102, such as searches, map views, business lookups, ads or web pages viewed, navigation systems, travel planning, locations mentioned in email, social network posts, and other communications, locations from photo or video imagery, geo-tagged data files such as images, purchases, payment system transactions, etc. In yet other embodiments, the location processing module geolocates the client computer based on user preferences, such as locations (e.g., businesses) identified by user selections (e.g., bookmarks, “likes”, “+1's”, etc.) or otherwise distinguished locations, such as businesses or other addresses stored in a user's address book. Moreover, any combination of the location estimation techniques may be used. In some embodiments, the system 100 includes additional location systems that determine the location of the client computer 102 using global-positioning system (GPS) estimates, assisted-GPS (A-GPS) estimates, cellular tower location estimates, or other location estimation techniques.

Using geolocation, the location system 108 determines a location set 116 from the token 114. Additionally, as described above, the location system 108 determines the location of the client computer 102 from additional locating data 118, such as historical behavior associated with the client computer 102 or the user 104. As shown in FIG. 1, the location set includes multiple locations 120. In some embodiments, the locations 120 are hierarchical such that a location at a level encompasses the hierarchical locations at lower levels. The locations 120 in the location set 116 includes, for example, a postal code, an official or colloquial neighborhood, a colloquial region, a city, a metropolitan area, an advertising region, a political district, a state, a province, a county, a parish, a country, or any other geographical area or combination thereof. Additionally, the determination of each location 120 includes an associated probability 122. The probability for a location indicates the likelihood that the geolocation estimation is accurate, i.e., that the client computer 102 is within the geographical region specified by the location. The locations 116 include, for example, a first location L1 and associated probability P1, a second location L2 and associated probability P2, and a third location L3 and associated probability P3.

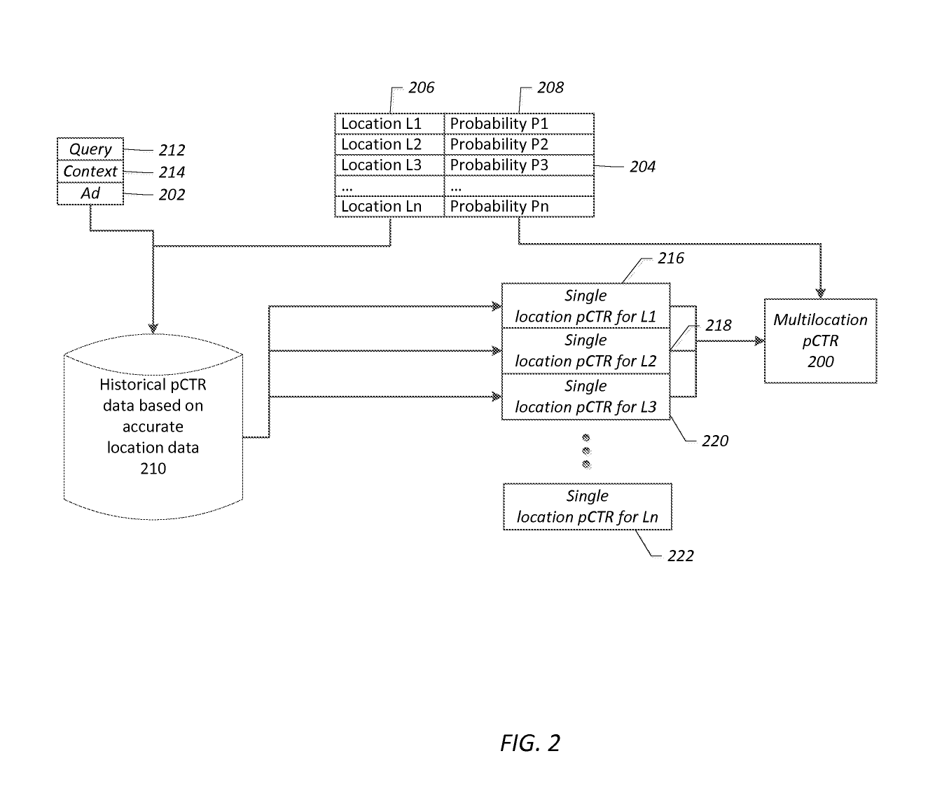

The advertisement system 110 selects and provides advertisements based on requests provided from the client computer 102, such as a search query 124. As shown in FIG. 1, the search query 124 is transmitted over the network 106 and received by the advertisement system 110. The advertisement system 110 determines a multilocation pCTR 126 for a given advertisement based on the location set 116. As described further below, the multilocation pCTR 126 is determined from single location pCTR's 128 for each location 120 of the location set 116. Each single location pCTR 128 for a given advertisement is determined as a function of the query 124, a context 130, the advertisement 132, and a location received from the location set 116. As described further below in FIG. 2, the single location pCTR's 128 are determined from data obtained from historical click-through rates for similar search queries, advertisements, contexts, and locations. The context may include a location context and other information, such as user demographics (e.g., age, gender, etc.), environmental conditions (e.g., time of day, holiday such as Christmas or Thanksgiving, etc.), or any other suitable information or combination thereof.

After determining the multilocation pCTR 126 for an advertisement, the advertisement is selected for an advertisement auction 134. In some embodiments, the multilocation pCTR 126 is used to rank advertisements in the advertisement auction 134. Potential advertisers may bid on the advertisements in the advertisement auction 134, and advertisements are selected based on the bids. Next, selected advertisements 136 from the advertisement auction 134 are provided over the network 106 to the client computer 102. For example, a webpage may be generated having the selected advertisements with search results responsive to the search query 124, and the generated webpage may be transmitted over the network 106 for display on the client computer 102. In some embodiments, the advertisement system 110 includes or communicates with a webserver for serving webpages.

FIG. 2 depicts the determination of a multilocation pCTR 200 for an advertisement 202 in accordance with embodiments of the present invention. As described above, the multilocation pCTR 200 for an advertisement 202 is determined for a location set 204 having locations 206 (e.g., L1, L2, L3 . . . Ln) and associated probabilities 208 (e.g., P1, P2, P3 . . . Pn). The multilocation pCTR 200 is determined based on single location pCTR's for each location 206 of the location set 204. In some embodiments, the multilocation pCTR for an advertisement A and a location set LS is determined according to the following equation:

pCTR(Q, A, C, LS)=pCTR(Q, A, C, L1)* P1+pCTR(Q, A, C, L2)*P2+pCTR(Q, A, C, L3)*P3+ . . . +pCTR(Q, A, C, Ln)*Pn

### Where:

LS is the location set;
Q is the search query;
A is the advertisement;
C is the context;
Ln is an nth location of the location set LS;
Pn is an nth probability associated with the nth location;
pCTR(Q,A,C,LS) is the multilocation pCTR for a location set LS;
pCTR(Q,A,C,Ln) is the single location pCTR for an nth location of the location set LS;

As shown in FIG. 2, in some embodiments the determination of a single location pCTR is based on historical click-through rate (CTR) data 210 for verified locations. For example, the historical CTR data is accumulated for relatively accurate location estimates having a single location, such as global positioning system (GPS) estimates or assisted GPS (A-GPS) estimates, Wi-Fi network location estimates, cell tower location estimates, and the like.

The single location pCTR for each location 206 of the location set 204 is obtained from the historical CTR data 210. As described above, the single location pCTR is a function of a query, a context, an advertisement, and a location. Thus, as shown in FIG. 2, the pCTR for the advertisement 202 and a location are obtained from a query 212, a context 214, and the location 206 from the location set 204. The historical CTR data for similar parameters are used to obtain the single location pCTR for each location, e.g., single location pCTR 216 for location L1, single location pCTR 218 for location L2, single location pCTR 220 for location L3, up to single location pCTR 222 for location Ln. Once the single location pCTR's are obtained, the multilocation pCTR 200 is determined from the single location pCTR's 216, 218, 220, and 222 and the associated probabilities 208 (e.g., P1, P2, P3 . . . Pn) by using Equation 1 described above.

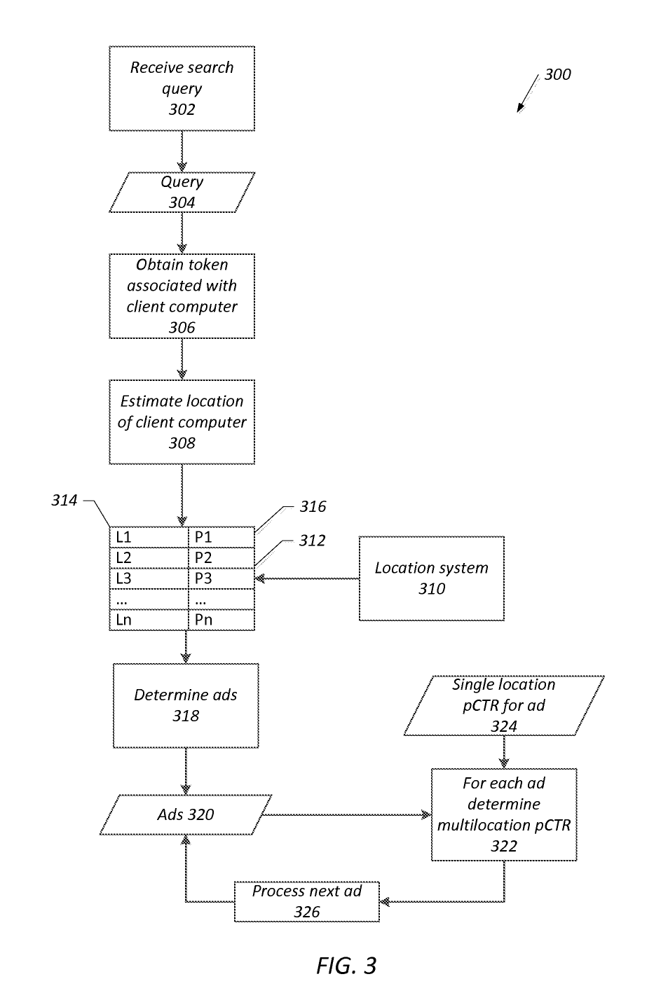

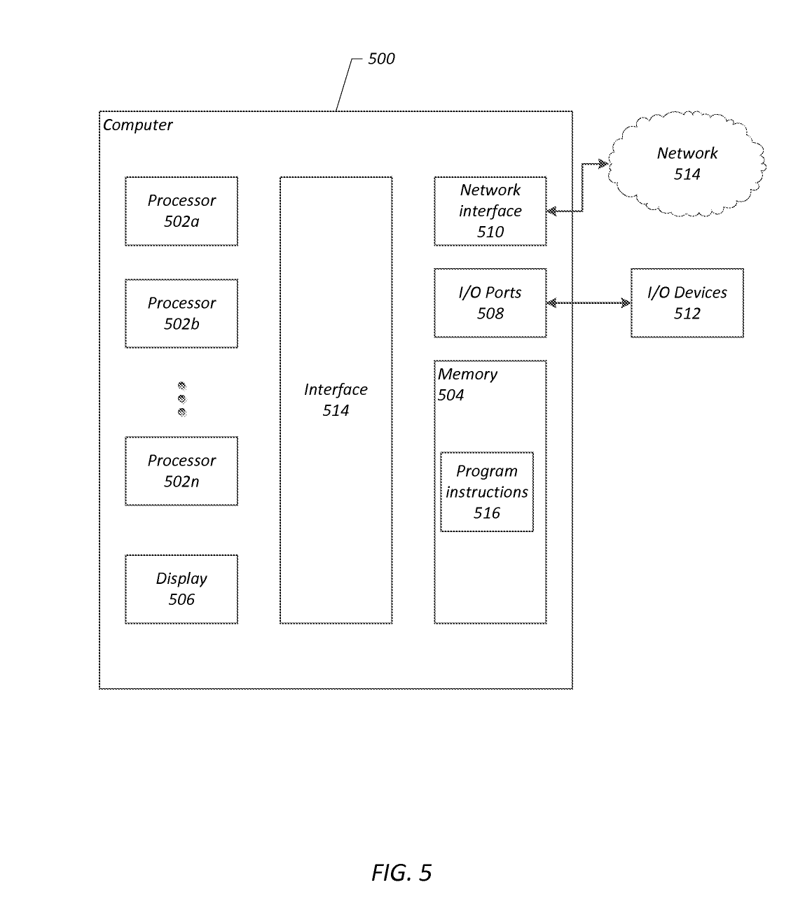

FIG. 3 depicts a process 300 for estimating a user's location and determining a multilocation pCTR in accordance with embodiments of the present invention. Some or all steps of the process 300 are implemented as executable computer code instructions stored on one or more non-transitory tangible computer-readable storage medium, such as described below in FIG. 5, and executed by one or more processors of a special-purpose machine, e.g., a computer programmed to execute the code. Initially, a search query 304 is received from a client computer (block 302). Next, a token (e.g., one or more tokens), such as an IP address, associated with the client computer is obtained (block 306). As noted above, the location of the client computer is estimated based on the token and other information (block 308), such though IP address geolocation. As also described above, the location of the client computer is estimated by a location system 310 that provides a location set 312.

The location set 312 includes a list of locations and associated probabilities that indicate the likelihood that the client computer is located within each location of the location set 314. For example, as shown in FIG. 3, the location set 312 includes locations 314 (e.g., locations L1, L2, L3 . . . Ln) and associated probabilities 316 (e.g., probabilities P1, P2, P3 . . . Pn). Next, eligible advertisements 320 based on the location, user information, the query, and other criteria or combination thereof are determined (block 318). For each advertisement, the multilocation pCTR is determined (block 322). As described above in FIG. 2 and in Equation 1, the multilocation pCTR is determined from the single location pCTR's 324 for each location. The determination of multilocation pCTR's then processes the next advertisement (block 326) until all advertisements have a determined multilocation pCTR value.

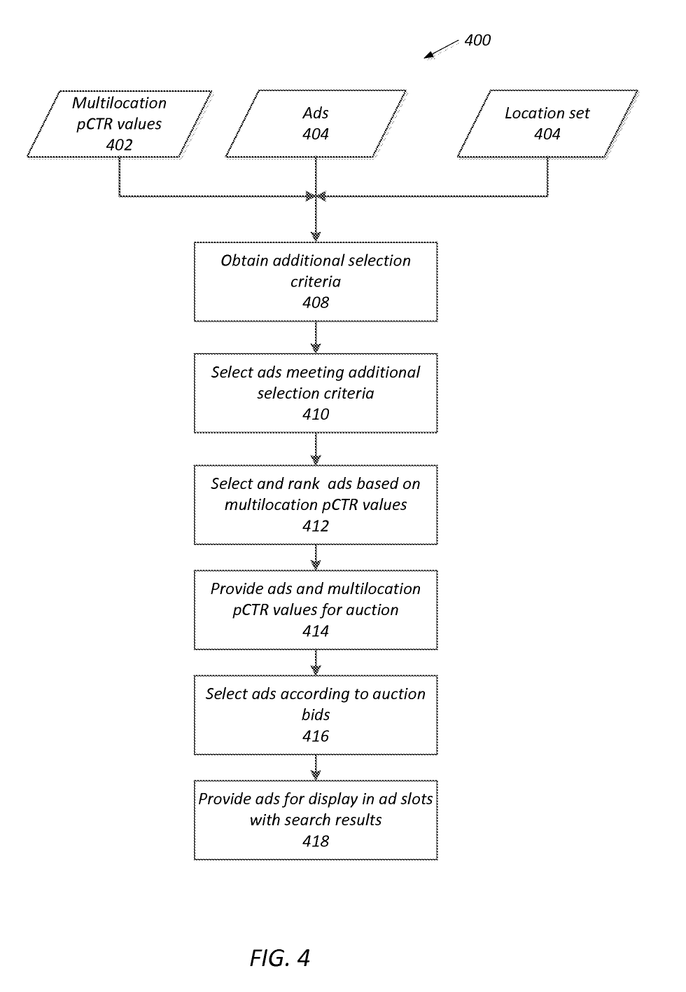

FIG. 4 depicts a process 400 for using multilocation pCTR values 402 in advertisement auctions in accordance with embodiments of the present invention. Some or all steps of the process 400 are implemented as executable computer code instructions stored on one or more non-transitory tangible computer-readable storage medium, such as described below in FIG. 5, and executed by one or more processors of a special-purpose machine, e.g., a computer programmed to execute the code. The inputs to the process 400 includes advertisements 404, the associated multilocation pCTR values 402, and the location set 406 corresponding to the location of the user initiating the request that generated potential advertising. In some embodiments, additional selection criteria for selecting the advertisements to be auctioned are obtained (block 408). The additional selection criteria are based on advertiser restrictions on locations. For example, an advertiser restricts certain advertisements from being eligible for certain locations.

Next, the advertisements meeting the additional selection criteria are selected for the auction (block 410). In some embodiments, the selection is based a single location of the location set or multiple locations of the location set. For example, in some embodiments, if an advertiser places location restrictions on an advertisement, the location restrictions are compared to the highest probable location of the location set, i.e., the location associated with the highest probability. In other embodiments, the location restrictions are compared to multiple locations of the location set, such that any location of the location set that meets the location restrictions may result in selection of an advertisement.

Next, advertisements are selected, ranked, or both based on the multilocation pCTR values (block 412). In some embodiments, the multilocation pCTR for each advertisement is compared to a threshold, such that advertisements having a multilocation pCTR above the threshold are selected for an auction. Additionally, in some embodiments the multilocation pCTR values are used to rank advertisements, such as for providing a ranking at an auction. After selecting advertisements, the advertisements and multilocation pCTR's are provided to an advertisement auction (block 414). The advertisement auction enables advertisers to place bids on advertisements and advertisement slots (corresponding to advertisement placement on a webpage). Additionally, the multilocation pCTR may also be provided to the auction to enable advertisers to evaluate the effectiveness of an advertisement for an estimate user's location (as determined by the location set). In some auctions, the multilocation pCTR for an advertisement is used in the calculation of the price of the advertisement. For example, the price of an advertisement may be calculated as a function of an advertiser's bid and the multilocation pCTR for the advertisement. Advantageously, the multilocation pCTR may increase advertiser participation and competition in the advertisement auction by attracting advertisers from multiple locations, thereby increasing bids and the amount paid for each advertisement.

After the auction, the advertisements are selected based on the auction bids (block 416). For example, the highest bid results in selection of an advertisement for a first advertisement slot on a webpage, the second-highest bid results in selection of an advertisement for a second advertisement slot on a webpage, and so on. In other embodiments, the advertisement auction may be for a single advertisement slot on a webpage. The advertisement auction may be a second price auction such that the amount paid by the winner of the auction equals the second-highest bid price. After selection, the advertisements are provided for display in advertisement slots with search results responsive to the search query. For example, the selected advertisements are transmitted over a network with the search results to a client computer and displayed as a webpage in a browser, or in other formats and in other applications.

FIG. 5 depicts a computer 500 in accordance with an embodiment of the present invention. Various portions or sections of systems and methods described herein include or are executed on one or more computers similar to computer 500 and programmed as special-purpose machines executing some or all steps of methods described above as executable computer code. Further, processes and modules described herein may be executed by one or more processing systems similar to that of computer 500.

The computer 500 may include various internal and external components that contribute to the function of the device and which may allow the computer 500 to function in accordance with the techniques discussed herein. As will be appreciated, various components of computer 500 may be provided as internal or integral components of the computer 500 or may be provided as external or connectable components. It should further be noted that FIG. 5 depicts merely one example of a particular implementation and is intended to illustrate the types of components and functionalities that may be present in computer 500.

Computer 500 may include any combination of devices or software that may perform or otherwise provide for the performance of the techniques described herein. For example, computer 500 may include or be a combination of a cloud-computing system, a data center, a server rack or other server enclosure, a server, a virtual server, a desktop computer, a laptop computer, a tablet computer, a mobile telephone, a personal digital assistant (PDA), a media player, a game console, a vehicle-mounted computer, or the like. The computer 500 may be a unified device providing any one of or a combination of the functionality of a media player, a cellular phone, a personal data organizer, a game console, and so forth. Computer 500 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

In addition, the computer 500 may allow a user to connect to and communicate through a network 514 (e.g., the Internet, a local area network, a wide area network, etc.) and to acquire data from a satellite-based positioning system (e.g., GPS). For example, the computer 500 may allow a user to communicate using e-mail, text messaging, instant messaging, or using other forms of electronic communication, and may allow a user to obtain the location of the device from the satellite-based positioning system, such as the location on an interactive map. As shown in FIG. 5, the computer 500 may include one or more processors (e.g., processors 502a-502n) coupled to a memory 504, a display 506, I/O ports 508 and a network interface 150, via an interface 514.

In one embodiment, the display 506 may include a liquid crystal display (LCD) or an organic light emitting diode (OLED) display, although other display technologies may be used in other embodiments. The display 506 may display a user interface (e.g., a graphical user interface). The display 506 may also display various function and system indicators to provide feedback to a user, such as power status, call status, memory status, etc. These indicators may be in incorporated into the user interface displayed on the display 506. In accordance with some embodiments, the display 506 may include or be provided in conjunction with touch sensitive elements through which a user may interact with the user interface. Such a touch-sensitive display may be referred to as a “touch screen” and may also be known as or called a touch-sensitive display system.

The processor 502 may provide the processing capability required to execute the operating system, programs, user interface, and any functions of the computer 500. The processor 502 may include one or more processors, such as “general-purpose” microprocessors and general and special purpose microprocessors, such as ASICs. For example, the processor 502 may include one or more reduced instruction set (RISC) processors, such as those implementing the Advanced RISC Machine (ARM) instruction set. Additionally, the processor 502 may include single-core processors and multicore processors and may include graphics processors, video processors, and related chip sets. A processor may receive instructions and data from a memory (e.g., system memory 504). Accordingly, computer 500 may be a uni-processor system including one processor (e.g., processor 502a), or a multi-processor system including any number of suitable processors (e.g., 502a-502n). Multiple processors may be employed to provide for parallel or sequential execution of one or more sections of the techniques described herein. Processes, such as logic flows, described herein may be performed by one or more programmable processors executing one or more computer programs to perform functions by operating on input data and generating corresponding output.

The memory 504 (which may include one or more tangible non-transitory computer readable storage medium) may include volatile memory and non-volatile memory accessible by the processor 502 and other components of the computer 500. The memory 504 may store a variety of information and may be used for a variety of purposes. For example, the memory 504 may store executable computer code, such as the firmware for the computer 500, an operating system for the computer 500, and any other programs or other executable code necessary for the computer 500 to function. The executable computer code may include program instructions 516 executable by a processor (e.g., one or more of processors 502a-502n) to implement one or more embodiments of the present invention. Instructions 516 may include modules of computer program instructions for implementing one or more techniques described herein with regard to various processing modules. Program instructions 516 may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, a subroutine. A computer program may or may not correspond to a file in a file system. A program may be stored in a section of a file that holds other programs or data (e.g., one or more scripts stored in a markup language document), in a single file dedicated to the program in question, or in multiple coordinated files (e.g., files that store one or more modules, sub programs, or sections of code). A computer program may be deployed to be executed on one or more computer processors located locally at one site or distributed across multiple remote sites and interconnected by a communication network. In addition, the memory 504 may be used for buffering or caching during operation of the computer 500.

As mentioned above, the memory 504 may include volatile memory, such as random access memory (RAM). The memory 504 may also include non-volatile memory, such as ROM, flash memory, a hard drive, any other suitable optical, magnetic, or solid-state storage medium, or a combination thereof. The memory 504 may store data files such as media (e.g., music and video files), software (e.g., for implementing functions on computer 500), preference information (e.g., media playback preferences), lifestyle information (e.g., food preferences), exercise information (e.g., information obtained by exercise monitoring equipment), transaction information (e.g., information such as credit card information), wireless connection information (e.g., information that may enable media device to establish a wireless connection such as a telephone connection), subscription information (e.g., information that maintains a record of podcasts or television shows or other media a user subscribes to), telephone information (e.g., telephone numbers), and any other suitable data.

The interface 514 may include multiple interfaces and may couple various components of the computer 500 to the processor 502 and memory 504. In some embodiments, the interface 514, the processor 502, memory 504, and one or more other components of the computer 500 may be implemented on a single chip, such as a system-on-a-chip (SOC). In other embodiments, these components, their functionalities, or both may be implemented on separate chips. The interface 514 may be configured to coordinate I/O traffic between processors 502a-502n, system memory 504, network interface 150, I/O devices 512, other peripheral devices, or a combination thereof. The interface 514 may perform protocol, timing or other data transformations to convert data signals from one component (e.g., system memory 504) into a format suitable for use by another component (e.g., processors 502a-502n). The interface 514 may include support for devices attached through various types of peripheral buses, such as a variant of the Peripheral Component Interconnect (PCI) bus standard or the Universal Serial Bus (USB) standard.

The computer 500 may also include an input and output port 508 to allow connection of additional devices, such as I/O devices 512. Embodiments of the present invention may include any number of input and output ports 508, including headphone and headset jacks, universal serial bus (USB) ports, Firewire or IEEE-1394 ports, and AC and DC power connectors. Further, the computer 500 may use the input and output ports to connect to and send or receive data with any other device, such as other portable computers, personal computers, printers, etc.

The computer 500 depicted in FIG. 5 also includes a network interface 150, such as a wired network interface card (NIC), wireless (e.g., radio frequency) receivers, etc. For example, the network interface 150 may receive and send electromagnetic signals and communicate with communications networks and other communications devices via the electromagnetic signals. The network interface 150 may include known circuitry for performing these functions, including an antenna system, an RF transceiver, one or more amplifiers, a tuner, one or more oscillators, a digital signal processor, a CODEC chipset, a subscriber identity module (SIM) card, memory, and so forth. The network interface 150 may communicate with networks (e.g., network 514), such as the Internet, an intranet, a cellular telephone network, a wireless local area network (LAN), a metropolitan area network (MAN), or other devices by wireless communication. The communication may use any suitable communications standard, protocol and technology, including Ethernet, Global System for Mobile Communications (GSM), Enhanced Data GSM Environment (EDGE), a 3G network (e.g., based upon the IMT-2000 standard), high-speed downlink packet access (HSDPA), wideband code division multiple access (W-CDMA), code division multiple access (CDMA), time division multiple access (TDMA), a 4G network (e.g., IMT Advanced, Long-Term Evolution Advanced (LTE Advanced), etc.), Bluetooth, Wireless Fidelity (Wi-Fi) (e.g., IEEE 802.11a, IEEE 802.11b, IEEE 802.11g or IEEE 802.11n), voice over Internet Protocol (VoIP), Wi-MAX, a protocol for email (e.g., Internet message access protocol (IMAP) or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), Multimedia Messaging Service (MMS), Short Message Service (SMS), or any other suitable communication protocol.

Those skilled in the art will also appreciate that, while various items are illustrated as being stored in memory or on storage while being used, these items or sections of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer 500 may be transmitted to computer 500 via transmission media or signals such as electrical, electromagnetic, or digital signals, conveyed via a communication medium such as a network or a wireless link. Various embodiments may further include receiving, sending or storing instructions or data implemented in accordance with the foregoing description upon a computer-accessible medium. Accordingly, the present invention may be practiced with other computer system configurations.

Various embodiments may further include receiving, sending or storing instructions and/or data implemented in accordance with the foregoing description upon a computer-accessible medium. Generally speaking, a computer-accessible/readable storage medium may include a non-transitory storage media such as magnetic or optical media, (e.g., disk or DVD/CD-ROM), volatile or non-volatile media such as RAM (e.g., SDRAM, DDR, RDRAM, SRAM, etc.), ROM, etc., as well as transmission media or signals such as electrical, electromagnetic, or digital signals, conveyed via a communication medium such as network and/or a wireless link.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed or omitted, and certain features of the invention may be utilized independently, all as would be apparent to one skilled in the art after having the benefit of this description of the invention. Changes may be made in the elements described herein without departing from the spirit and scope of the invention as described in the following claims. Headings used herein are for organizational purposes only and are not meant to be used to limit the scope of the description.

As used throughout this application, the words “may” and “can” each is used in a permissive sense (i.e., meaning having the potential to), rather than the mandatory sense (i.e., meaning must). The words “include”, “including”, and “includes” mean including, but not limited to. As used throughout this application, the singular forms “a”, “an” and “the” include plural referents unless the content clearly indicates otherwise. Thus, for example, reference to “an element” includes a combination of two or more elements. Unless specifically stated otherwise, as apparent from the discussion, it is appreciated that throughout this specification discussions utilizing terms such as “processing”, “computing”, “calculating”, “determining” or the like refer to actions or processes of a specific apparatus, such as a special purpose computer or a similar special purpose electronic processing/computing device. In the context of this specification, a special purpose computer or a similar special purpose electronic processing/computing device is capable of manipulating or transforming signals, typically represented as physical electronic or magnetic quantities within memories, registers, or other information storage devices, transmission devices, or display devices of the special purpose computer or similar special purpose electronic processing/computing device.

What is claimed is:

1. A computer-implemented method for determining a multilocation predicted click-through rate for advertisements, the method comprising:
receiving, at one or more processors, a search query from a client computer;
receiving, at one or more processors, a location set corresponding to the client computer, the location set comprising a plurality of locations associated with a respective plurality of probabilities that the client computer is located at a respective location of the plurality of locations;
receiving, at one or more processors, a plurality of advertisements based on the search query;
determining, by one or more processors, a multilocation predicted click-through rate (pCTR) for each of the plurality of advertisements, the multilocation pCTR comprising a function of the plurality of locations, a single location pCTR for each location of the location set, and the respective plurality of probabilities; and
providing, by one or more processors, one or more of the plurality of advertisements to an advertisement auction based on the multilocation pCTR, whereby advertisers may bid the one the one or more advertisements in the advertisement auction.

2. The computer-implemented method of claim 1, further comprising selecting, by one or more processors, one of the plurality of advertisements based on the results of the advertisement auction and transmitting over a network, by one or more processors, the selected advertisement to the client computer for display with search results responsive to the search query.

3. The computer-implemented method of claim 1, wherein providing, by one or more processors, one or more of the plurality of advertisements to an advertisement auction comprises ranking, by one or more processors, one or more of the plurality of advertisements based on the multilocation pCTR.

4. The computer-implemented method of claim 1, wherein providing, by one or more processors, one or more of the plurality of advertisements to an advertisement auction comprises comparing, by one or more processors, the multilocation pCTR for each of the one or more advertisements to a threshold value.

5. The computer-implemented method of claim 4, wherein providing, by one or more processors, one or more of the plurality of advertisements to an advertisement auction comprises discarding, by one or more processors, one or more the plurality of advertisements based on the comparison.

6. The computer-implemented method of claim 1, wherein the multilocation pCTR comprises a sum of the single-location pCTR for each location of the location set multiplied by the probability associated with each location.

7. The computer-implemented method of claim 1, wherein the single-location pCTR is a function of a plurality of factors including at least one of: the query, one of the plurality of advertisements, and one of the plurality of locations.

8. The computer implemented method of claim 7, wherein the single-location pCTR is determined from historical click-through rate data for the location.

9. The computer-implemented method of claim 1, further comprising selecting, by one or more processors, one or more of the plurality of advertisements for the advertisement auction based on eligibility criteria, and wherein the eligibility criteria comprises a location restriction provided by one or more advertisers.

10. The computer-implemented method of claim 9, further comprising comparing the location restriction to only one of the plurality of locations.

11. The computer-implemented method of claim 9, further comprising comparing the location restriction to each of the plurality of locations.

12. A non-transitory tangible computer-readable storage medium having executable computer code stored thereon for determining a multilocation predicted click-through rate for advertisements, the code comprising a set of instructions that causes one or more processors to perform the following:
receiving, at one or more processors, a search query from a client computer;
receiving, at one or more processors, a location set corresponding to the client computer, the location set comprising a plurality of locations associated with a respective plurality of probabilities that the client computer is located at a respective location of the plurality of locations;
receiving, at one or more processors, a plurality of advertisements based on the search query;
determining, by one or more processors, a multilocation predicted click-through rate (pCTR) for each of the plurality of advertisements, the multilocation pCTR comprising a function of the plurality of locations, a single location pCTR for each location of the location set, and the respective plurality of probabilities; and
providing, by one or more processors, one or more of the plurality of advertisements to an advertisement auction based on the multilocation pCTR.

13. The non-transitory computer-readable storage medium of claim 12, the code comprising a set of instructions that causes one or more processors to perform the following:
selecting, by one or more processors, one of the plurality of advertisements based on the results of the advertisement auction and transmitting over a network, by one or more processors, the selected advertisement to the client computer for display with search results responsive to the search query.

14. The non-transitory computer-readable storage medium of claim 12, wherein providing, by one or more processors, one or more of the plurality of advertisements to an advertisement auction comprises ranking, by one or more processors, one or more of the plurality of advertisements based on the multilocation pCTR.

15. The non-transitory computer-readable storage medium of claim 12, wherein the multilocation pCTR comprises a sum of a single-location pCTR for each location of the location set multiplied by the probability associated with each location.

16. The non-transitory computer-readable storage medium of claim 15, wherein the single-location pCTR is a function of a plurality of factors including at least one of the query, one of the plurality of advertisements, one of the plurality of locations, and a context.

17. A system for determining a multilocation predicted click-through rate for advertisements, the system comprising one or more processors; and
non-transitory memory accessible by the one or more processors, the memory having computer code stored thereon, the code comprising a set of instructions that causes one or more processors to perform the following:
receiving, at one or more processors a search query from a client computer;
receiving, at one or more processors, a location set corresponding to the client computer, the location set comprising a plurality of locations associated with a respective plurality of probabilities that the client computer is located at a respective location of the plurality of locations;
receiving, at one or more processors, a plurality of advertisements based on the search query;
determining, by one or more processors, a multilocation predicted click-through rate (pCTR) for each of the plurality of advertisements, the multilocation pCTR comprising a function of the plurality of locations, a single location pCTR for each location of the location set, and the respective plurality of probabilities; and
providing, by one or more processors, one or more of the plurality of advertisements to an advertisement auction based on the multilocation pCTR.

18. The system of claim 17, wherein the computer code further comprises a set of instructions that causes one or more processors to perform the following:
selecting, by one or more processors, one of the plurality of advertisements based on the results of the advertisement auction and transmitting over a network, by one or more processors, the selected advertisement to the client computer for display with search results responsive to the search query.

19. The system of claim 17, wherein the instruction of providing, by one or more processors, one or more of the plurality of advertisements to an advertisement auction comprises ranking, by one or more processors, one or more of the plurality of advertisements based on the multilocation pCTR.

20. The system of claim 17, wherein the multilocation pCTR comprises a sum of a single-location pCTR for each location of the location set multiplied by the probability associated with each location.

21. The system of claim 17, wherein the single-location pCTR is a function of a plurality of factors including at least one of the query, one of the plurality of advertisements, one of the plurality of locations, and a context.
